(19) United States
(12) Patent Application Publication
(10) Pub. No.: US 2014/0338319 A1
(43) Pub. Date: Nov. 20, 2014

(54) HYDRAULIC HYBRID SAFETY SYSTEM

(71) Applicant: FEV GmbH, Aachen (DE)

(72) Inventors: Kiumars Jalali, Rochester Hills, MI (US); Martin Pischinger, Munich (DE)

(73) Assignee: FEV GmbH, Aachen (DE)

(21) Appl. No.: 13/897,903

(22) Filed: May 20, 2013

(51) Int. Cl. F15B 1/02

(52) U.S. Cl. CPC F15B 1/02
USPC 60/413

(57) ABSTRACT

A hydraulic hybrid safety system is provided. The hydraulic hybrid safety system is part of a hydraulic hybrid system that has an over-center bent-axis rotary pump/motor with a yoke, the yoke having a zero yoke angle and a plurality of non-zero yoke angles. The safety system includes a spring that is operable to move the yoke to the zero yoke angle when the hydraulic hybrid system loses electrical power.

### FIELD OF THE INVENTION

The present invention is related to a hydraulic hybrid system, and in particular to a hydraulic hybrid system that has a fail-safe system.

### BACKGROUND OF THE INVENTION

Hydraulic hybrid vehicles (HHVs) that use pressurized fluid, instead of electric power, in combination with an internal combustion engine are known. The presence of a hydraulic powertrain allows for improved fuel economy and reduction of the greenhouse gas emissions compared to a conventional vehicle and a hydraulic hybrid system (HHS) can be less expensive than an electric hybrid system.

The HHS uses a pressurized working fluid stored in a high pressure accumulator to power or turn a motor and thus provide additional or alternative power to a motor vehicle. In addition, low pressure working fluid can be pumped by the internal combustion engine or during braking of the vehicle in order to provide high pressure working fluid which is stored in the high pressure accumulator.

The HHS is typically controlled by electrical control valves that control the flow of the high pressure and low pressure working fluid. However, upon certain failures of the HHS, the continued flow of high pressure working fluid can result in unintended movement of the vehicle at undesired times. Examples of such certain failures include loss of electrical power, local controller failure, local valve failure, global power failure of the system, isolated or local failure of the system, and the like. Therefore, a hydraulic hybrid safety system that results in the reduction or elimination of undesired movement by a hybrid hydraulic vehicle would be desirable.

### SUMMARY OF THE INVENTION

A hydraulic hybrid system (HHS) with a fail-safe system is provided. The hydraulic hybrid safety system (HHSS) is part of a HHS that has an over-center bent-axis rotary pump/motor (hereafter simply referred to as a “pump/motor”) and a high pressure accumulator and a low pressure accumulator in fluid communication with the pump/motor. The pump/motor has a yoke that can be oriented at a zero yoke angle (0°) or at one of a plurality of non-zero yoke angles. In addition, the pump/motor has a zero torque when the yoke is at the zero yoke angle, thereby resulting in zero displacement of the hydraulic fluid, and a non-zero torque when the yoke is at a non-zero yoke angle and thereby resulting in non-zero displacement of the hydraulic fluid.

The HHSS has a spring that is operable to move the yoke to the zero yoke angle when the hydraulic hybrid system. In some instances, the spring is attached to the yoke and may or may not be part of a pulley and cord system in which the cord is attached to and extends between the spring and the yoke. In other instances, the spring is attached symmetrically about a yoke pivot axis.

The HHS can have a pair of control cylinders that are attached to the yoke and operable to move the yoke between the zero yoke angle and the plurality of non-zero yoke angles during operation of the hydraulic hybrid system. Also, the spring can be a pair of springs and the pair of control cylinders can each have one of the pair of springs such that the pair of springs afford for the yoke to move to the zero yoke angle if the HHS experiences a failure. Each of the pair of control cylinders may or may not have one of the springs located therewithin.

In still other instances, the HHS includes a pair of spring cylinders attached to the yoke in addition to the pair of control cylinders. In such instances, the HHSS has a pair of springs with one of the springs located within each of the spring cylinders. Similar to the pair springs working in combination with the control cylinders, the pair springs in combination with the spring cylinders afford for movement of the yoke to the zero angle when the hydraulic hybrid system loses power.

### BRIEF DESCRIPTION OF THE DRAWINGS

FIG. 1 is a schematic diagram of a series hydraulic hybrid motor vehicle;

FIG. 2 is a schematic illustration of an over-center bent-axis rotary pump/motor;

FIG. 3A is a schematic illustration of a hydraulic hybrid system;

FIG. 3B is a schematic illustration of a variation of a hydraulic hybrid system;

FIG. 4 is a schematic illustration of a hydraulic hybrid safety system (HHSS) according to an embodiment of the present invention;

FIG. 5 is a schematic illustration of a HHSS according to an embodiment of the present invention;

FIG. 6 is a schematic illustration of a HHSS according to an embodiment of the present invention;

FIG. 6A illustrates a portion of the schematic illustration of a HHSS according to an embodiment of the present invention;

FIG. 6B illustrates the surfaces of the cylinder cup faces of the piston faces;

FIG. 7 is a schematic illustration of a HHSS according to an embodiment of the present invention;

FIG. 8 is a schematic illustration of a HHSS according to an embodiment of the present invention;

FIG. 9 is a schematic illustration of valve fail-safe positions for a HHSS according to an embodiment of the present invention; and

FIG. 10 is a schematic illustration of valve fail-safe positions for a HHSS according to an embodiment of the present invention.

### DETAILED DESCRIPTION OF THE INVENTION

A hydraulic hybrid safety system (HHSS) for a hydraulic hybrid system (HHS) is provided. The HHSS can be used as part of a motor vehicle HHS and thus has used as a component for a motor vehicle.

The HHSS can be used for and/or be part of a HHS that has and/or uses an over-center bent-axis rotary pump/motor. The pump/motor has a yoke operable to be located or positioned at a plurality of yoke angles. In addition, the yoke can have a zero yoke angle (YA 0°) and a plurality of non-zero yoke angles. It is appreciated that the pump/motor has or produces zero torque when the yoke is at a zero degrees and no fluid displacement occurs. It is also appreciated that the pump/motor has or produces torque when the yoke is at a non-zero degree.

The HHS has a high pressure accumulator and a low pressure accumulator that are in a closed loop fluid communication with the pump/motor. A spring is also included as part of the HHSS, the spring being operable to move the yoke to the zero yoke angle if the HHS experiences a failure and equal pressures apply to the control cylinders. In addition, the spring affords for the yoke to move to the zero yoke angle in a very short time period. For example, the HHSS moves the yoke to the zero yoke angle and thus affords for the pump/motor to have zero torque within a time period of less than 120 milliseconds (msec). In some instances, the HHSS affords for the yoke to move to the zero yoke angle within a time period of less than 100 msec. In still other instances, the HHSS affords for the yoke to move to the zero yoke angle within a time period of less than 75 msec.

Referring now to FIG. 1, a schematic illustration of a motor vehicle is shown generally at reference numeral 10. The motor vehicle 10 can have an internal combustion engine 100, a transmission 110, a drive gear 120, and tires 130. It is appreciated that the internal combustion engine 100 has a crankshaft 102 in communication with a transmission input shaft 112. In addition, the transmission 110 has a driveshaft 114 in communication with the drive gear 120.

In addition to the internal combustion engine 100, the vehicle 10 has a hydraulic hybrid system 200 that includes a high pressure accumulator 210 and a low pressure accumulator 220. The high pressure accumulator 210 has a high pressure working fluid stored therewithin and affords for flow of the working fluid to a hydraulic pump/motor 240 through a hydraulic line 212 and a high pressure inlet line 214. It is important to note that line 214 can be used as inlet or outlet depending on the operation mode of the system. The working fluid can then pass via the pump/motor 240 and flow into the low pressure accumulator 220 via a low pressure outlet line 226 and a hydraulic line 222. It should be appreciated that when the high pressure working fluid flows from the high pressure accumulator 210 to the low pressure accumulator 220, the pump/motor 240 serves as a motor to provide energy to the tires 130. In the alternative, the pump/motor 240 working as a motor can be used to start the internal combustion engine 100.

In reverse, the low pressure working fluid from the low pressure accumulator 220 can pass to the pump/motor 240 through the hydraulic line 222 and a low pressure inlet line 224 It is important to note that line 224 can be used as inlet or outlet depending on the operation mode of the system. Upon reaching the pump/motor 240, the low pressure working fluid can be pumped to provide high pressure working fluid which is stored in the high pressure accumulator 210 via the high pressure outlet line 216 and the hydraulic line 212. It is appreciated that the pump/motor 240 receives power to pump from the internal combustion engine 100 and/or kinetic energy during braking of the motor vehicle 10.

The internal combustion engine 100 can rotate the crankshaft 102 as illustrated by the arrow 103 and thus provide energy to the pump/motor system 240 and/or the high pressure accumulator and the generated hydraulic energy can be used to charge the high pressure accumulator and/or be used to move the vehicle. In addition, the transmission 110 can afford for the driveshaft 114 to turn in a clockwise or counterclockwise direction as illustrated by the double-headed arrow 115 such that the vehicle 10 is moved in a forward or rearward direction. In addition, and as discussed in more detail below, the pump/motor can afford for the inlet shaft 112 to the transmission 110 to be rotated in a clockwise or counterclockwise direction as shown by the double-headed arrow 116.

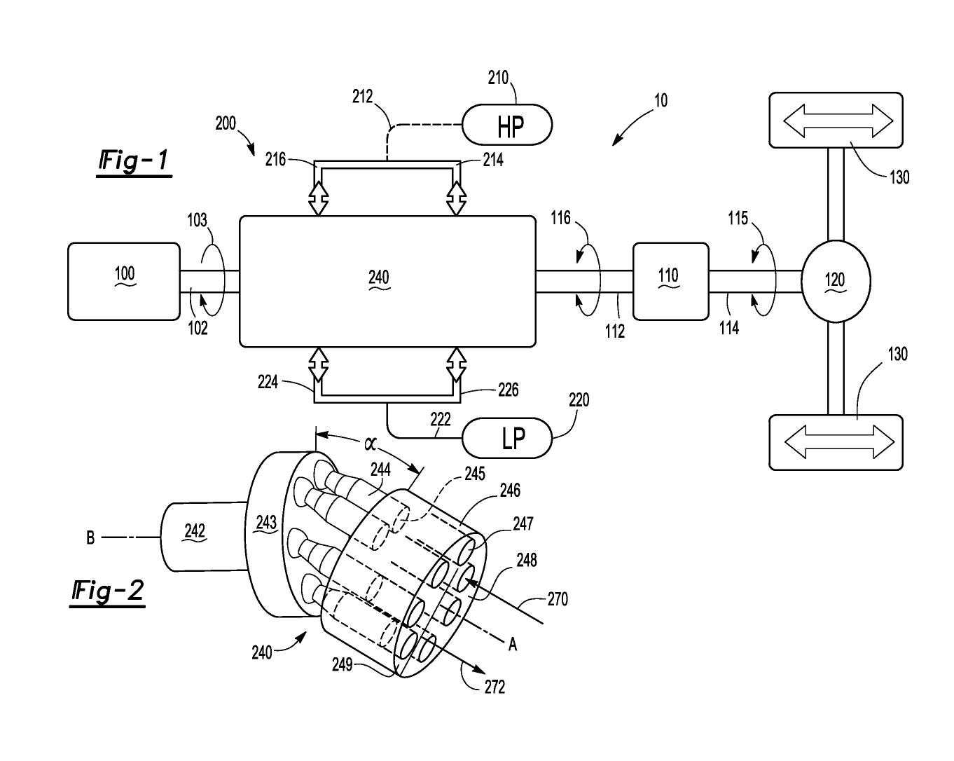

Referring now to FIG. 2, a schematic illustration of a pump/motor 240 in the form of an over-center bent-axis pump/motor is shown. The pump/motor 240 has an output shaft 242 coupled to a drive plate 243. The drive plate 243 has a plurality of sockets that engage heads of a plurality of pistons 244 as is known to those skilled in the art. The pistons 244 have a piston face 245 that is located within a cylinder 247 of a cylinder housing 246. The cylinder housing 246 has a high pressure side 248 and a low pressure side 249 which varies depending upon an angle between the drive plate 243 and the cylinder housing 246. This angle, also known as a yoke angle (α), can vary from a positive value as shown in FIG. 2, to zero as described or discussed above, to a negative value in which the cylinder housing 246 would be oriented in an upward angle in FIG. 2 compared to the downward angle currently shown.

The cylinder housing 246 is configured to rotate around a first axis A while the drive plate 243 and driveshaft 242 rotate around a second axis B. It is appreciated that the cylinder housing 246 and the driveshaft 242 rotate at a common rate.

The pump/motor 240 is configured for the yoke angle between the drive plate and the face of the cylinder housing 246 to vary. In addition, with the ability to change the yoke angle, the cylinder housing 246 and pistons 244 vary the displacement volume of the pump/motor 240. It is appreciated that the motor 240 can have cylinders directly opposite one another such that when one cylinder 247 is at top-dead-center (TDC), another cylinder is at bottom-dead-center (BDC). In the alternative, the motor 240 can have an odd number of cylinders.

In operation, the cylinders 247 rotate around the axis A and high pressure fluid is valved into each cylinder as it passes BDC as illustrated by arrow 270. The high pressure fluid applies a driving force on the piston faces 245, the driving force being transferred by the pistons 244 to the drive plate 243. As each piston 244 passes TDC, the working fluid is vented from the appropriate cylinder 247 as illustrated by arrow 272 and thus allows the piston 244 to be pushed back into its cylinder as the cylinder housing 246 rotates it back toward BDC.

One skilled in the art would appreciate that with the pump/motor 240 having a positive yoke angle α as shown in FIG. 2, pressure exerted on the pistons 244 within their respective cylinders 247 on the high pressure side 248 of the cylinder housing 246 will drive the drive plate 243 in a counterclockwise direction when viewed in a direction indicated by the arrow 270. The amount of torque generated is directly related to the yoke angle with the magnitude of the torque diminishing toward zero as the yoke angle approaches zero. However, as the yoke angle moves to a negative angle, the pressure will tend to drive the motor in an opposite direction, e.g. the clockwise direction. In this manner, the pump/motor can be used to move the motor vehicle in a forward or rearward direction. In addition, if the pump/motor 240 is caused to rotate against an applied torque, e.g. a torque provided by the internal combustion engine 100 or generated through the kinetic energy of the vehicle while braking 10, the pump/motor 240 will function as a pump and draw fluid into the cylinders 247 on the low pressure side 249 and force the fluid out of the cylinders on the high pressure side, assuming the yoke angle is positive as illustrated in FIG. 2.

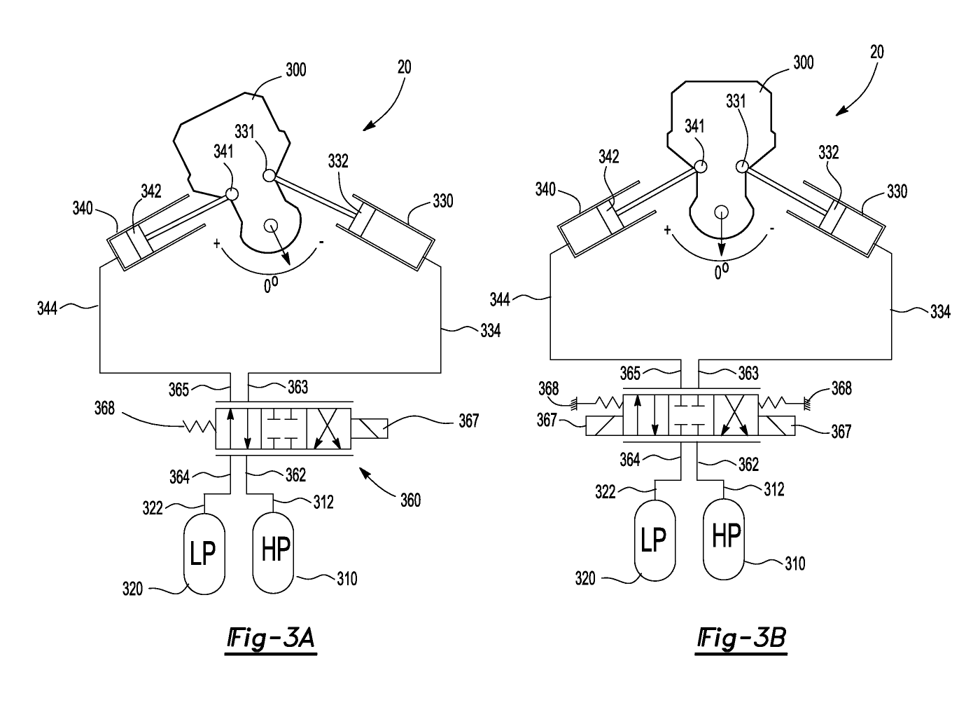

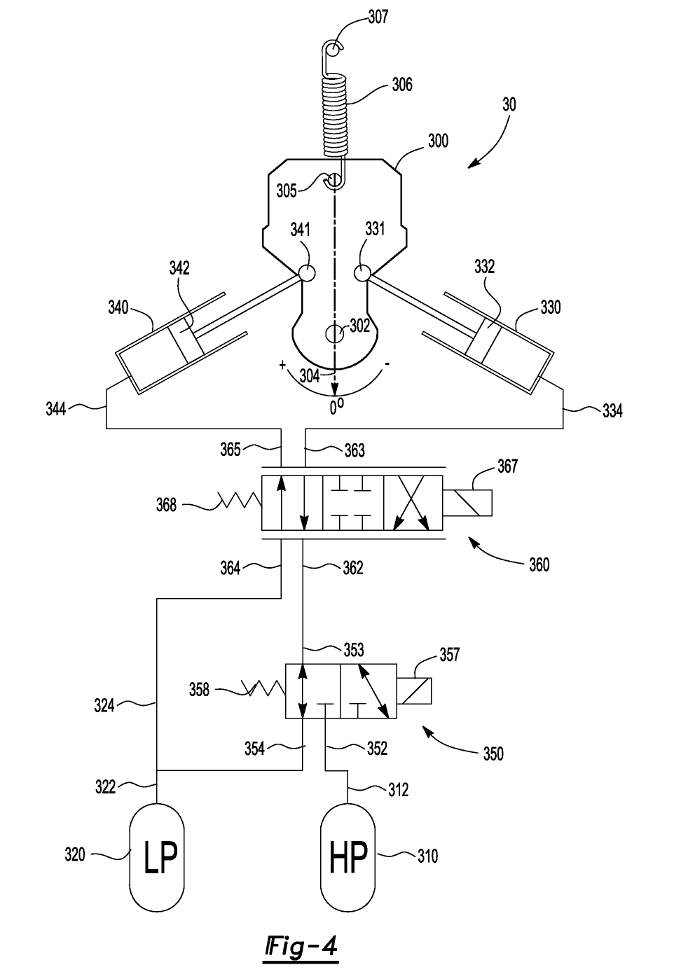

Referring now to FIG. 3A, a current state of the art yoke angle control system is shown generally at reference numeral 20. The yoke control system controls a yoke 300 with a pair of control cylinders 330, 340 that have pistons 332, 342, respectively, that are attached to the yoke 300 at 331, 341. The control cylinders 330, 340 are in fluid communication with a high pressure accumulator 310 and a low pressure accumulator 320. Between the control cylinders 330, 340 and the high pressure accumulator 310 and low pressure accumulator 320 is a proportional single-sided 4×3 electrically controlled displacement control valve 360. The control valve 360 has high pressure inlet line 362 and a low pressure inlet line 364. In addition, a solenoid switch 367 in combination with a spring 368 affords for movement of the valve 360 as known to those skilled in the art.

As shown in FIG. 3A, in the event that the HHS experiences a failure, the valve 360 will move to its default position where high pressure working fluid will be supplied to control cylinder 330 and move the yoke 300 to a maximum yoke angle which affords for maximum torque from the over-center bent-axis pump. Naturally, such a configuration is undesirable if the vehicle 10 is at a location where movement of the vehicle is undesired.

FIG. 3B shows another configuration in which the control valve 360 has a pair of springs 368 such that upon loss of electrical power, the yoke angle of the yoke 300 at the time of power loss is maintained. In the event that the yoke angle is zero, the pump/motor 240 will have zero torque. However, in the event that the yoke angle is non-zero, the pump/motor 240 will continue to have a non-zero torque causing unintended vehicle movement.

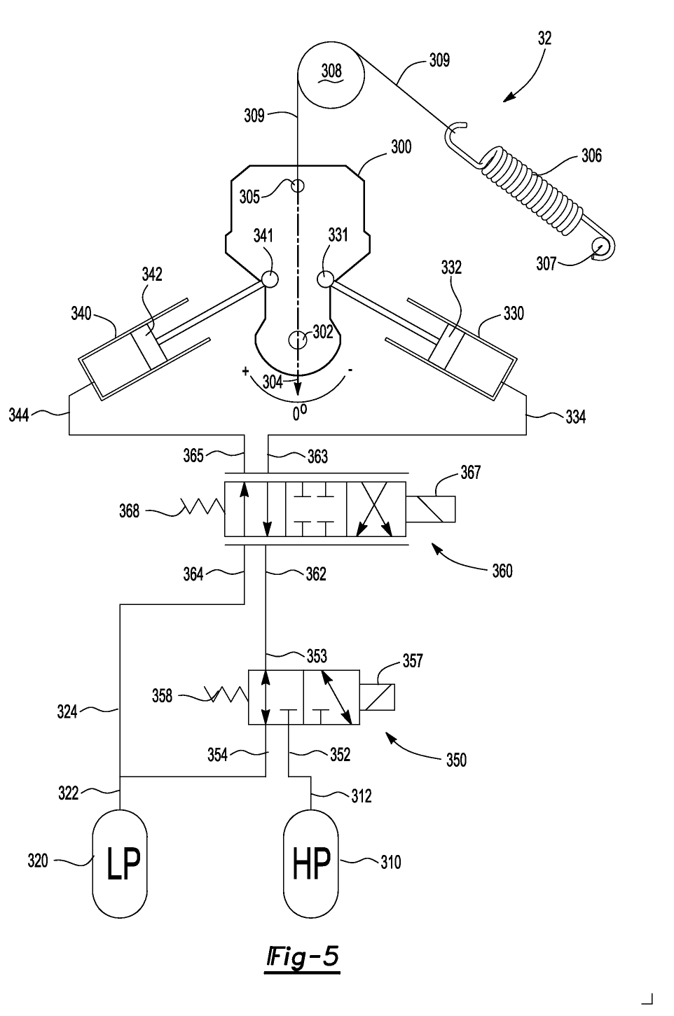

Referring to FIG. 4, an inventive HHSS according to an embodiment of the present invention is shown generally at reference numeral 30. The safety system 30 is used with the yoke 300; pair of control cylinders 330, 340; high pressure accumulator 310; and low pressure accumulator 320. Similar to the system shown in FIG. 3, the HHS includes pistons 332 and 342 that are attached to the yoke 300. In addition, the high pressure accumulator 310 has a hydraulic line 312 that provides high pressure fluid to a high pressure inlet line 352 of a 3×2 control valve 350. The control valve 350 has a solenoid switch 357 and a spring 358. In addition, it should be appreciated that the inventive hydraulic system shown in FIG. 4 includes the non-proportional control valve 350 with simple or simplified on/off operation that affords for the valve in its default position to provide low pressure hydraulic fluid to both control cylinders 330, 340.

The low pressure accumulator 320 has a low pressure hydraulic line 322 that can branch into a low pressure inlet line 354 to the control valve 350 and a low pressure hydraulic line 324 that feeds a low pressure inlet line 364 to the proportional control valve 360. The control valve 360 has two hydraulic lines, 363 and 365, which feed or are in fluid communication with the control cylinders 330, 340, respectively.

The system 30 also has a spring 306 that is attached to the yoke 300 at attachment point 305. In addition, the spring 306 has an external attachment point 307.

During operation of the hydraulic hybrid system, the yoke 300 can have a zero yoke angle or a non-zero yoke angle as illustrated by the angle indicator 304. In the event the HHS experiences a failure, the spring 306 biases the yoke 300 to the zero yoke angle.

FIG. 5 shows a different embodiment at reference numeral 32 in which the spring 306 is used in combination with a pulley 308 and a cord 309 that is attached to the attachment point 305, the spring 306 biasing the yoke 300 to the zero yoke angle. Similar to the embodiment shown in FIG. 4, the inventive hydraulic system or circuit with the non-proportional control valve 350 is used.

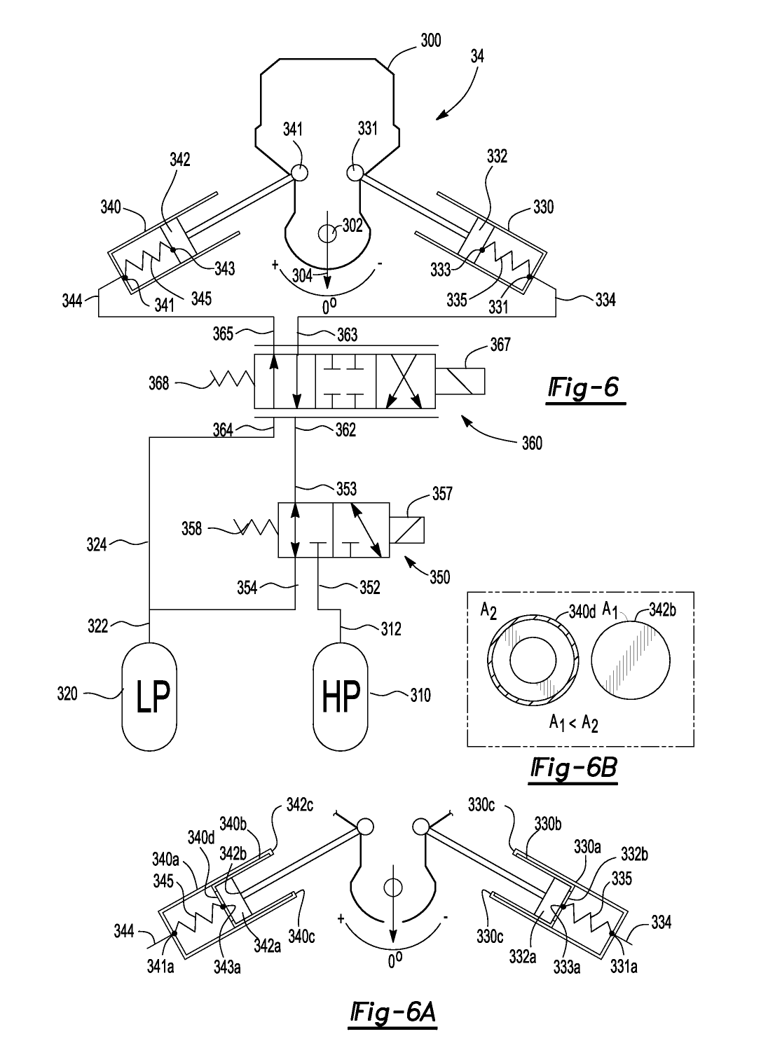

Referring now to FIG. 6, another embodiment of a hydraulic hybrid safety system is shown generally at reference numeral 34. The embodiment 34 uses a pair of springs 335, 345 that are located within the control cylinders 330, 340, respectively. In addition, the springs 335, 345 are in contact or engage the pistons 332, 342 and are attached to the control cylinders 330, 340 at attachment locations 331, 341, respectively, and pistons 332, 342 at attachment locations 333, 343 respectively as such in the figure. Upon experiencing a system failure, the control cylinders 330, 340 in combination with the springs 335, 345 move or bias the yoke 300 to the zero yoke angle. It should be appreciated that the appropriate or inventive hydraulic circuit that uses the non-proportional control valve 350 introduced earlier applies low pressure to both control cylinders when a failure happens.

The embodiment shown in FIG. 6 can also include the use of hydraulic cylinder cups 330h, 340h within control cylinders 330a, 340a. The cups 330b, 340b can be held within cylinders 330a. 340a by a mechanical stop 330c, 340c, respectively. In addition, the springs 335, 345 are only attached to the control cylinders 330a, 340a and cylinder cups 330b, 340b at attachment locations 331a, 333a and 341a, 343a, as shown. The pistons 332a and 342a can move inside the cylinder cups 330b and 340b, whereas the cylinder cups 330h and 340b can move inside the control cylinders 330a and 340a, respectively. Such a design will reduce the operation range of the pistons and cylinder cups by half and allows for the use of compression only springs 335 and 345 in the design. In addition, such a design also guarantees the holding and maintaining a zero yoke angle when a failure happens.

Any type of cylinder cup known to those skilled in the art can be used in the embodiments disclosed herein. For example and for illustrative purposes only, cylinder cups disclosed by Gray et al. in U.S. Pat. No. 8,356,895, the contents of which is included herein in its entirety by reference, can be used with the instant invention. Naturally, the surface area (A₁) of the piston face 332b, 342b must be less than the surface area (A₂) of the cylinder cup face 330d, 340d in order for pressure on the cup faces to dominate over pressure on the piston faces.

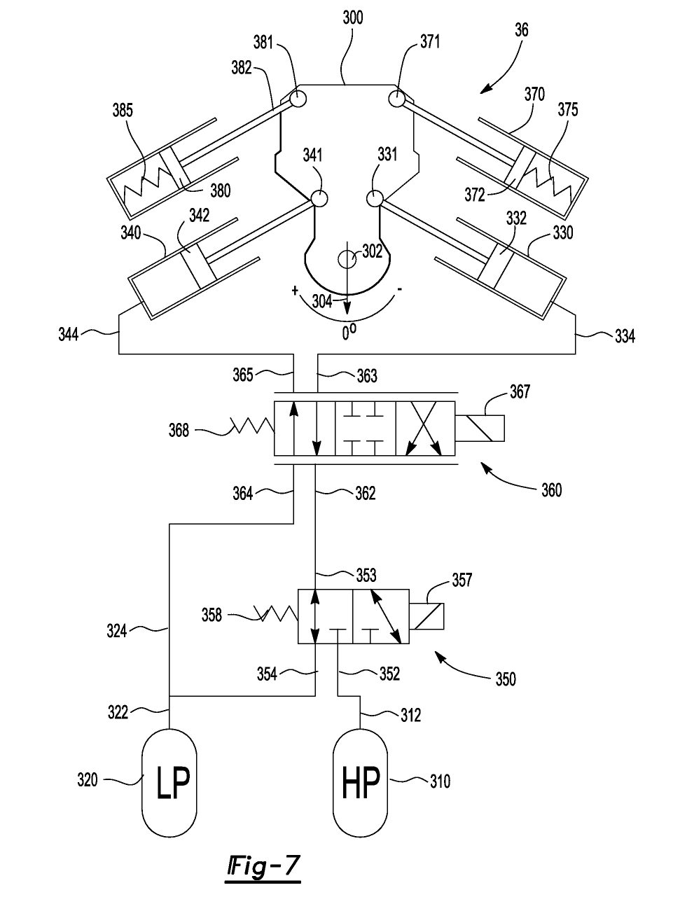

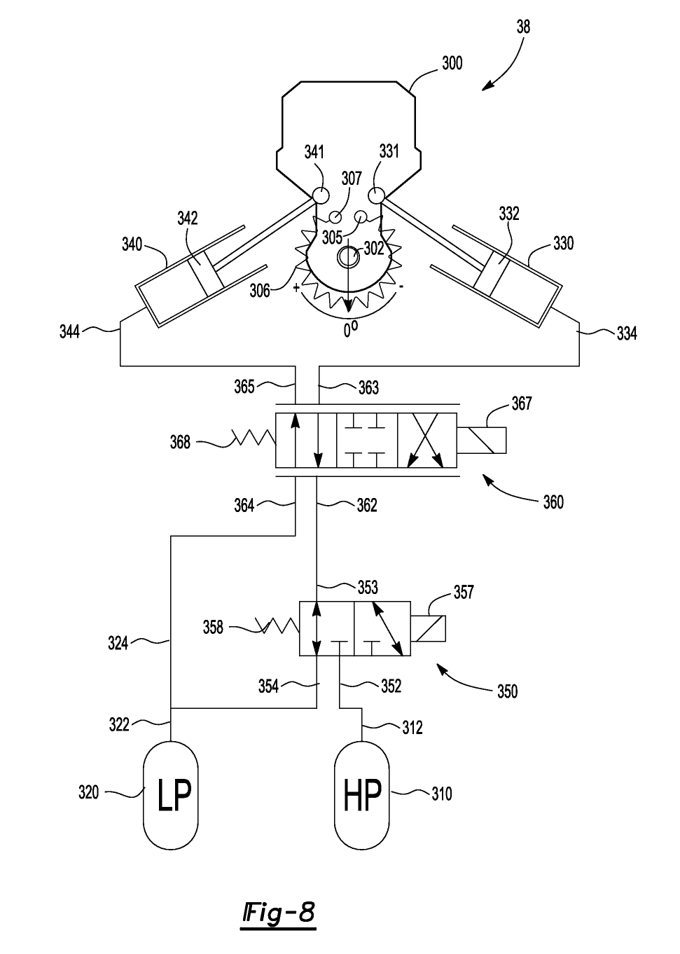

An embodiment in which a pair of additional spring cylinders is used as part of the hydraulic hybrid safety system is shown in FIG. 7 at reference numeral 36. The embodiment 36 includes the pair of control cylinders 330, 340 plus a pair of spring cylinders 370, 380, in addition to the previously introduced new hydraulic circuit. The pair of spring cylinders 370, 380 have a pair or pistons 372, 382 which are also in contact with the yoke 300 at 371, 381 respectively. In contact with or engaged with the pair of pistons 372, 382, and within the pair of spring cylinders 370, 380, is a pair of mechanical springs 375, 385. In a similar fashion as shown in FIG. 6, the pair of spring cylinders 370, 380 with the mechanical springs 375, 385 afford for movement of the yoke 300 to the zero yoke angle upon a system failure, in addition to applying low pressure to both control cylinders using the new hydraulic circuit and thereby provide a fail-safe HHS. Referring now to FIG. 8, another embodiment is shown generally at reference numeral 38 in which the yoke 300 has a pivot axis 302 and the torsional spring 306 is located symmetrically about this axis. The spring 306 has a pair of spring anchors/attachment points 305, 307 which do not move or rotate when the yoke 300 is placed in a non-zero yoke angle and thus the spring 306 applies tension to the yoke to bring it back to the zero yoke angle. As such, when the system of embodiment 38 experiences a failure, the spring 306 biases the yoke 300 to the zero yoke angle while low pressure is applied to both control cylinders using the new hydraulic circuit.

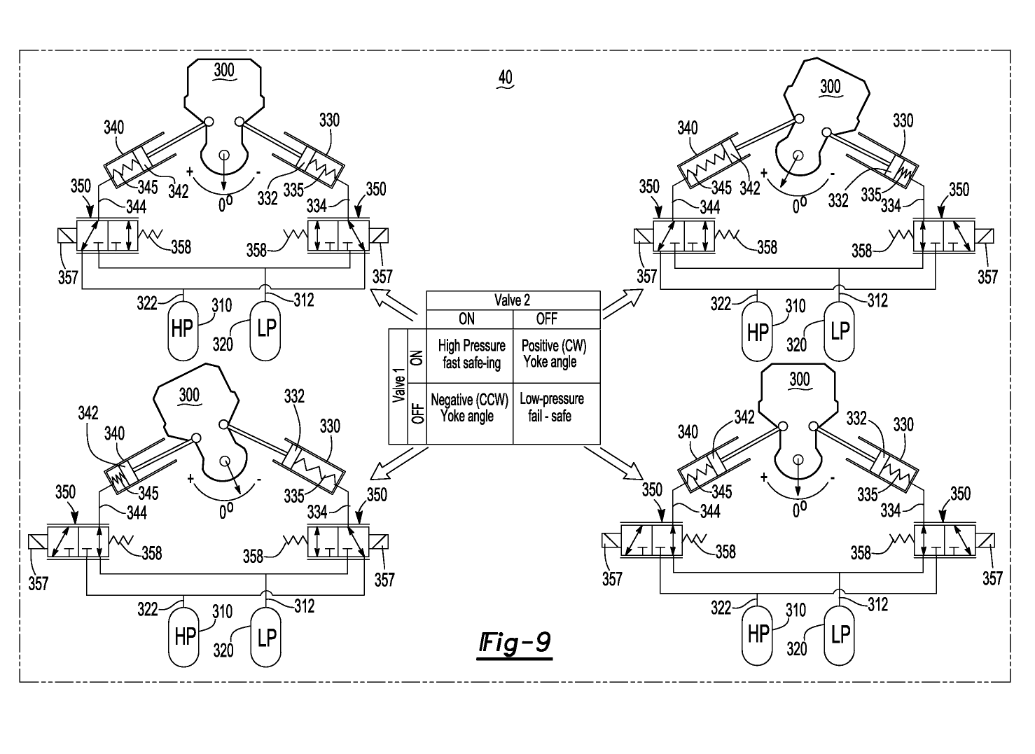

Referring now to FIG. 9, another embodiment of a HHSS is shown generally at reference numeral 40. The embodiment 40 includes two proportional 3×2 control valves 350 to control the control cylinders 330, 340. The table shown in FIG. 9 illustrates the functionality of this embodiment in which a fast safe-ing of the system is obtained when both of the valves 350 are in the “ON” position applying high pressure to both control cylinders. A low pressure fail-safe configuration is provided when both of the valves are in an “OFF” position and low pressure is applied to the control cylinders. The other two diagrams in FIG. 9 illustrate the control of the yoke angle through the appropriate control of the proportional control valves 350 to the positive or negative yoke angles. It is appreciated that activating both valves at the same time such that high pressure is applied to both control cylinders 330, 340 brings the yoke 300 back to its neutral position, i.e. zero yoke angle. Likewise, the same is true when the valves stop the flow of working fluid from the high pressure accumulator 310 to the control valves 330, 340 and allow the flow of low pressure working fluid to both of the control cylinders.

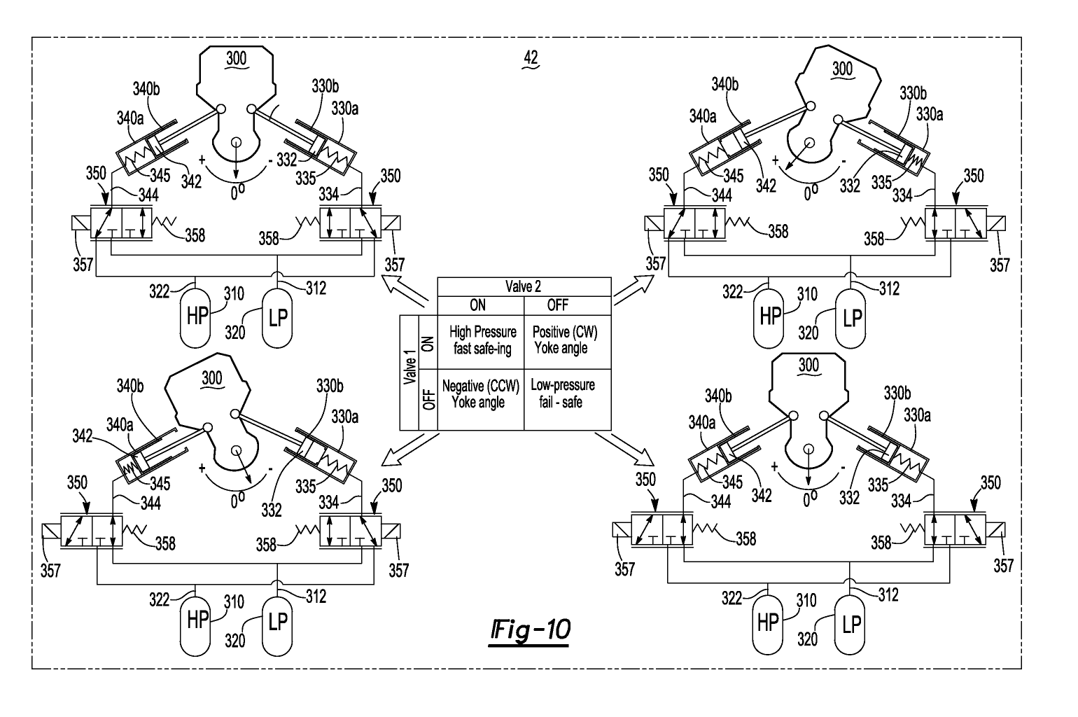

FIG. 10 provides an alternative embodiment at reference numeral 42 in which similar 3×2 proportional control valves are employed, but hydraulic cylinder cups 330b, 340b are used in addition to control cylinders 330a, 340a. The springs 335, 345 are only attached to the control cylinders 330a, 340a and cylinder cups 330b, 340h as discussed above and the springs hold the cups in a default position inside the control cylinders 330a, 340a with both control valves 350 switched off and connecting the control cylinders 330a and 340a to the low pressure accumulator 320. It is appreciated that the cylinder cups 330b, 340b are restricted in their motion by design and ensure that the yoke 300 is maintained at the zero yoke angle regardless of slight spring rite differences between the two springs 335, 345. In addition, applying hydraulic pressure to one side of the system 42 results in hydraulic pressure overcoming spring force and hydraulic pressure on the other side, and thus moving the yoke to its commanded yoke angle. However, when high pressure is applied to both sides, the yoke is brought to its zero yoke angle much faster than when only the use of the mechanical springs is employed. This is due to the pressure surface difference between the cylinder cups 330b, 340b and the actual pistons 332 and 342, thereby causing a higher hydraulic force on the cylinder cups than that on the pistons.

The above embodiments and examples are provided for illustrative purposes only and are not meant to limit the scope of the invention in any way. Changes, modifications, etc. by one skilled in the art will be evident and yet still fall within the scope of the invention. For example, the hydraulic hybrid safety systems disclosed herein allow a hydraulic hybrid system to switch to low pressure when a failure of electrical power occurs and the one or more mechanical springs generate required torque to bring the yoke to a zero yoke position if it was initially at a non-zero yoke position. Moreover, the embodiments disclosed herein eliminate the need for an additional hydraulic system and control algorithm to bring the yoke to a zero yoke angle each and every time a motor vehicle is started. Given the above, the scope of the invention is identified by the claims and all equivalents thereof.

1. A hydraulic hybrid safety system comprising:
a hydraulic hybrid system having:
an over-center bent-axis rotary pump/motor having a yoke, said yoke having a zero yoke angle and a plurality of non-zero yoke angles, said pump/motor having zero torque when said yoke angle is at said zero yoke angle and non-zero torque when said yoke is at a non-zero yoke angle;
a high pressure accumulator in fluid communication with said pump/motor;
a low pressure accumulator in fluid communication with said pump/motor; and
a spring, said spring operable to move said yoke to said zero yoke angle when said hydraulic hybrid system loses electrical power.

2. The hydraulic hybrid safety system of claim 1, wherein said spring is attached to said yoke.

3. The hydraulic hybrid safety system of claim 2, further comprising a pulley and a cord, said cord attached to and extending between said spring and said yoke and along said pulley, said pulley located between said spring and said yoke.

4. The hydraulic hybrid safety system of claim 2, wherein said yoke has a pivot axis and said spring is attached to said yoke symmetrically about said pivot axis.

5. The hydraulic hybrid safety system of claim 1, further comprising a pair of control cylinders attached to said yoke and operable to move said yoke between said zero yoke angle and said plurality of non-zero yoke angles during operation of said hydraulic hybrid system.

6. The hydraulic hybrid safety system 5, wherein said spring is a pair of springs and said pair of control cylinders each have one of said pair of springs, said pair of springs in combination with said pair of control cylinders operable to move said yoke to said zero yoke angle when said hydraulic hybrid system loses power.

7. The hydraulic hybrid system of claim 6, wherein each of said pair of control cylinders each has one of said pair of springs located therewithin.

8. The hydraulic hybrid safety system of claim 5, further comprising a pair of spring cylinders attached to said yoke, said spring being a pair of springs with each of said spring cylinders having one of said pair of springs, said pair of springs in combination with said pair of spring cylinders operable to move said yoke to said zero yoke angle when said hydraulic hybrid system loses power.

9. A motor vehicle hydraulic hybrid system comprising:
a high pressure accumulator;
a low pressure accumulator; and
an over-center bent-axis rotary pump/motor operable as motor and a pump, said pump/motor:
in fluid in communication with said high pressure accumulator and said low pressure accumulator;
having a yoke, said yoke moveable between a zero yoke angle and a plurality of non-zero yoke angles during operation of said pump/motor;
having zero torque when said yoke angle is at said zero yoke angle and non-zero torque when said yoke is at a non-zero yoke angle; and
in mechanical communication with an internal combustion and a transmission of said motor vehicle;
a safety system having a spring attached to said yoke of said pump/motor, said spring operable to move said yoke to said zero yoke angle when said hydraulic hybrid system loses power.

10. The motor vehicle hydraulic hybrid system of claim 9, wherein said spring is attached to said yoke.

11. The motor vehicle hydraulic hybrid system of claim 10, further comprising a pulley and a cord, said cord attached to and extending between said spring and said yoke and along said pulley, said pulley located between said spring and said yoke.

12. The motor vehicle hydraulic hybrid system of claim 10, wherein said yoke has a pivot axis and said spring is attached to said yoke symmetrically about said pivot axis.

13. The motor vehicle hydraulic hybrid system of claim 9, further comprising a pair of control cylinders attached to said yoke and operable to move said yoke between said zero yoke angle and said plurality of non-zero yoke angles during operation of said hydraulic hybrid system.

14. The motor vehicle hydraulic hybrid system of claim 13, wherein said spring is a pair of springs and said pair of control cylinders each have one of said pair of springs, said pair of springs in combination with said pair of control cylinders operable to move said yoke to said zero yoke angle when said hydraulic hybrid system loses power.

15. The motor vehicle hydraulic hybrid system of claim 14, wherein each of said pair of control cylinders each has one of said pair of springs located therewithin.

16. The motor vehicle hydraulic hybrid system of claim 13, further comprising a pair of spring cylinders attached to said yoke, said spring being a pair of springs with each of said spring cylinders having one of said pair of springs, said pair of springs in combination with said pair of spring cylinders operable to move said yoke to said zero yoke angle when said hydraulic hybrid system loses power.
